(19) United States
(12) Patent Application Publication
(10) Pub. No.: US 2012/0278381 A1
(43) Pub. Date: Nov. 1, 2012

(54) Integrating an Online Meeting with an Offline Calendar

(76) Inventors: Andrew Rodney Ferlitsch, Camas, WA (US); Gary Lin Gaebel, Vancouver, WA (US)

(21) Appl. No.: 13/097,777

(22) Filed: Apr. 29, 2011

(51) Int. Cl. G06F 15/16

(52) U.S. Cl. 709/203

(57) ABSTRACT

A method is provided for integrating an online meeting with an offline calendar. The method provides an offline calendar software application. A meeting originator (user) schedules a meeting in the offline calendar via a user interface, and selects a virtual room resource having an email address. The offline calendar sends an email meeting invitation to the virtual room resource email address. An online meeting service software application has an email client monitoring emails sent to the virtual room resource email address. The online meeting service automatically scheduling an online meeting associated with the virtual room resource.

### BACKGROUND OF THE INVENTION

1. Field of the Invention

This invention generally relates to online meeting and calendar software applications and, more particularly, to a system and method for integrating an offline calendar with online meeting scheduling.

2. Description of the Related Art

Almost all online meeting services have integrated some meeting scheduling functions with Microsoft's (MS's) Outlook calendar feature. Some examples of online meeting scheduling services include Cisco WebEx, Citrix GotoMeeting, Microsoft LiveMeeting, Adobe Connect, IBM Lotus Sametime, and DimDim. But each of these services requires non-automated steps to import a meeting scheduled in an MS Outlook calendar to an online meeting.

Cisco WebEx

The WebEx integration with MS Outlook requires a user to download and install a plugin into MS Outlook. The plugin adds a toolbar to Outlook, where the toolbar contains a tab for scheduling a meeting. The procedure to start an online meeting from OutLook is as follows:

1. Open MS Outlook's New Meeting function and schedule a meeting;

2. Select the WebEx tab;

3. Select online meeting enter additional information.

At this point, a meeting will he scheduled for bath MS Outlook calendar and the WebEx meeting service. Additionally, MS Outlook will send out an email invite message which contains a link to the online meeting. However, this method has the following limitations:

the user must install a plugin into the user's calendar program (e.g., MS Outlook), which is only downloaded to a paying account;

the user must perform manual steps (e.g., WebEx tab) after scheduling a meeting in the user's calendar program, to make the meeting an online meeting as well; and,

there is no means to import a document when scheduling the meeting.

Citrix GotoMeeting

The GotoMeeting integration with MS Outlook requires a user to download and install a plugin into MS Outlook. The plugin adds a toolbar to Outlook, where the toolbar contains a tab for scheduling a meeting, or for launching a meeting now. The procedure for starting an online meeting from OutLook is as follows:

1. Select Schedule Meeting from the GotoMeeting toolbar in Outlook;

2. Login into your GotoMeeting account;

3. Enter meeting information into the GotoMeeting menu;

4. Add email invitees when Outlook meeting schedule appears.

At this point, a meeting is scheduled for both MS Outlook calendar and the GotoMeeting meeting service. Additionally, MS Outlook sends out an email invite message which contains a link to the online meeting. However, this method has the following limitations:

the user must install a plugin into the user's calendar program (e.g., MS Outlook);

the user must perform manual steps (e.g., GotoMeeting tab) before scheduling a meeting in the user's calendar program, to make the meeting an online meeting as well;

the user must log into the service; and,

there is no means to import a document when scheduling a meeting.

Microsoft Live Meeting

The LiveMeeting integration with MS Outlook requires a user to download and install a plugin into MS Outlook. The plugin adds a toolbar to Outlook, where the toolbar contains a tab for scheduling a meeting, or for launching a meeting now. The procedure for starting an online meeting from OutLook is as follows:

1. Select the Scheduling Meeting from the LiveMeeting tab in Outlook;

2. Fill in the meeting information when Outlook meeting schedule appears.

At this point, a meeting is scheduled for both MS Outlook calendar and the Live Meeting meeting service. Additionally, MS Outlook sends out an email invite message which contains a link to the online meeting. However, this method has the following limitations:

the user must install a plugin into the user's calendar program (e.g., MS Outlook);

the user must schedule the meeting in the plugin's form, instead of the calendar's (Outlook) forms; and,

there is no means to import a document when scheduling a meeting.

Adobe Acrobat Connect

The Acrobat Connect integration with MS Outlook requires a user to download and install a plugin into MS Outlook. The plugin adds a toolbar to Outlook, where the toolbar contains a tab for scheduling a meeting. The procedure for starting an online meeting from OutLook is as follows:

1. Enter account information (one-time) after installing the plugin;

2. Select the Add Acrobat Meeting Room from the Acrobat Connect tab in Outlook;

2. Select the meeting room;

4. Fill in the meeting information when Outlook meeting schedule appears.

At this point, a meeting is scheduled for both MS Outlook calendar and the Acrobat Connect meeting service. Additionally, MS Outlook sends out an email invite message which contains a link to the online meeting. However, this method has the following limitations:

the user must install a plugin into the user's calendar program (e.g., MS Outlook)—the plugin download requires a paid account;

the user must enter (one-time) service login/account information;

the user must perform manual steps (e.g., using the Acrobat Connect tab) before scheduling a meeting in the user's calendar program, to make the meeting an online meeting as well; and,

there is no means to import a document when scheduling a meeting.

Dimdim

A meeting cannot he exported or scheduled from within MS Outlook. A Dimdim iCAL file can be downloaded and imported into MS Outlook.

IBM Lotus Sametime

The IBM website states as follows, “(i)n scheduling web conferences, a new tab has been added to the Calendar dialog of Outlook which allows the user to schedule web conferences, creating, changing, and deleting Sametime web conferences through the Calendar feature within Outlook. The meeting information is sent electronically in a meeting invitation.”

All of the aforementioned solutions require each meeting organizer to download and install a plugin into their MS Outlook client. Additionally, each has to perform at least one manual step when scheduling a meeting to indicate this is an online meeting.

It would be advantageous if an offline calendar program existed that could automatically schedule an online meeting, without the use of a plugin or manual non-native client calendar step.

### SUMMARY OF THE INVENTION

Almost all major online collaboration service providers offer a means of integration with the MS Outlook calendar. Disclosed herein is a method for integration that requires neither a plugin nor the performance of manual, user enacted steps. In an exemplary Operating environment, the online meeting service may be enterprise hosted or hosted by a 3^{rd} party service. When scheduling the online meeting, the user performs typical tasks with scheduling an event in the offline calendar, including: 1) Setting Time and Location, 2) Inviting attendees, 3) Selecting a room resource, and 4) sending invites to the attendees. Each invited attendee has an email address associated with them. A meeting request is then sent to the email address of each attendee. Each attendee receives the email message via an email client running on a computing device, such as a PC, laptop or mobile device. The computing device from which the user operates the email client can additionally store or access documents, and send documents as attachments via email.

More explicitly, the user can automatically schedule an online meeting using their offline meeting calendar, and import documents into a scheduled or live meeting using the offline calendar. For example, a corporate email administrator creates a special email account for each physical meeting room, and designates each email account as a meeting resource, which is referred to herein as a virtual room resource. When a user schedules a meeting, they perform their normal operations, with one exception: when selecting a room resource, the user (meeting organizer) selects the resource associated with the room as an online meeting, as opposed to selecting the physical room resource. In some cases, the user may select both the online and physical meeting room resource. In other cases, the user may select the online meeting room as a participant instead of a resource, and may or may not select a physical room resource. When scheduling the meeting, the user may also include one or more documents in the scheduled meeting by importing them into scheduled meeting via the meeting calendar program.

When the user completes scheduling the meeting, the user selects SEND to cause the meeting calendar program to send an email meeting invite to each participant. An email meeting invite is also sent to the email address of the selected online meeting resource. The online meeting (room) service has an email client that monitors emails sent to the email address of the online meeting resource. When the email is received by the email meeting service client, the body of the email and its associated attachments are parsed. Preconfigured in the meeting service email client is the ability to recognize meeting invite messages from the offline calendar. When such an email message is recognized, the meeting service email client parses out the meeting information (e.g., time, location, organizer, agenda, attendees) from the email message according to a predetermined format for the email message.

Using the extracted information, the online meeting service email client automatically (programmatically) schedules an online meeting with the meeting service for the online meeting (room) resource according to the meeting information extracted from the email message. The online meeting service email client may also extract other information from the email message that is used in scheduling the meeting, whose format is generic to the email message. For example, if the email message contains documents as attachments, the documents can be added to the scheduled meeting as preloaded content. Additionally, the non-online meeting resource participants (attendees) can reply back to the email meeting invite to the online meeting resource with additional content which can he preloaded in the meeting or added to a live meeting.

Unlike prior art methods, a separate plugin need not be installed in the offline meeting calendar application. Neither is there the requirement of selecting buttons and filling in menus that are not native to the offline meeting calendar application (i.e. added by the plugin). Integration of an online meeting with the offline meeting calendar application is based solely on the format of that calendar application's email invite.

This disclosed method automatically schedules an online meeting from an offline calendar, as the result of an email invite message sent from the offline calendar to an email address monitored by the online meeting service. Preloaded content (e.g., file attachments) can be added into a scheduled meeting as a file attached to the meeting email invite. The meeting service sends a secondary email to all the participants with information specific to the online meeting, such as meeting login information, security information, etc.

Accordingly, a method is provided for integrating an online meeting with an offline calendar. The method provides an offline calendar software application. A meeting originator (user) schedules a meeting the offline calendar via a user interface, and selects a virtual room resource having an email address. The offline calendar sends an email meeting invitation to the virtual room resource email address. An online meeting service software application has an email client monitoring emails sent to the virtual room resource email address. The online meeting service automatically schedules an online meeting associated with the virtual room resource.

Additional details of the above-described method are provided below.

### BRIEF DESCRIPTION OF THE DRAWINGS

FIG. 1 is a schematic block diagram depicting a computing device capable of supporting the methods associated with the integration of an offline calendar with an online meeting.

FIG. 2 is a flowchart illustrating a method or integrating an online meeting with an offline calendar.

FIG. 3 is a flowchart illustrating a method for planning an online meeting from an offline calendar.

FIG. 4 is a schematic block diagram depicting participants integrating an offline calendar with an online meeting.

FIG. 5 is a flowchart illustrating the process by which the online service email client extracts meeting information from an email sent to a virtual room resource by offline calendar.

FIG. 6 is a drawing illustrating an invitation reply email.

FIG. 7 is a flowchart illustrating an invitation reply parsing process.

### DETAILED DESCRIPTION

As used in this application, the terms “component,” “module,” “system,” and the like may be intended to refer to an automated computing system entity, such as hardware, firmware, a combination of hard are and software, software, software stored on a computer-readable medium, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

The computer devices described below typically employ a computer system with a bus or other communication mechanism for communicating information, and a processor coupled to the bus for processing information. The computer system may also include a main memory, such as a random access memory (RAM) or other dynamic storage device, coupled to the bus for storing information and instructions to be executed by processor. These memories may also be referred to as a computer-readable medium. The execution of the sequences of instructions contained in a computer-readable medium may cause a processor to perform some of the steps associated with integrating an offline calendar with an online meeting service. Alternately, some of these functions may be performed in hardware. The practical implementation of such a computer system would be yell known to one with skill in the art.

As used herein, the term “computer-readable medium” refers to any medium that participates in providing instructions to a processor for execution. Such a medium may take many forms, including but not limited to, non-volatile media, volatile media, and transmission media. Non-volatile media includes, for example, optical or magnetic disks. Volatile media includes dynamic memory. Common forms of computer-readable media include, for example, a floppy disk, a flexible disk, hard disk, magnetic tape, or any other magnetic medium., a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

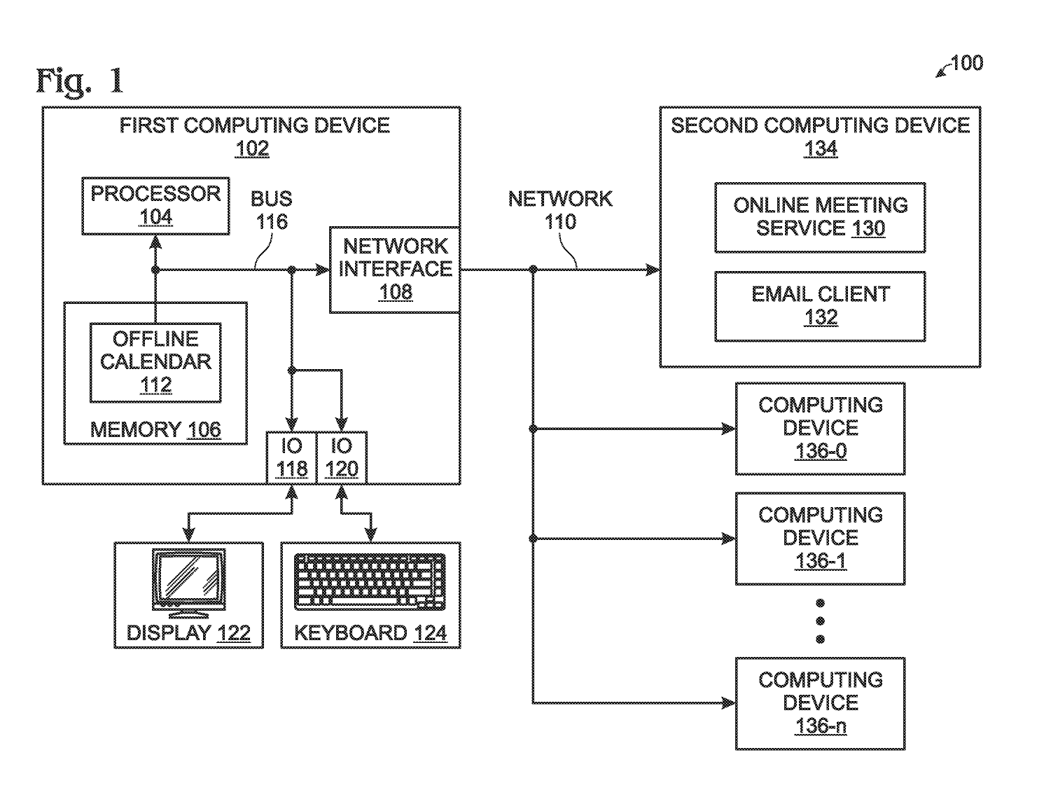

FIG. 1 is a schematic block diagram depicting a computing device capable of supporting the methods associated with the integration of an offline calendar with an online meeting. The system 100 comprises a first computing device 102 including a processor 104, a memory 106, and a network interface 108 connected to the network on line 110. An offline calendar application 112 is stored in the memory 106, and enabled as a software application of sequential instructions stored in the memory 106 and executed by the processor 104.

The first computing device 102 may be a personal computer (PC), workstation, server, or processor-enabled printer. The processor or central processing unit (CPU) 104 may be connected to memory 106 via an interconnect bus 116. The processor 104 may include a single microprocessor, or may contain a plurality of microprocessors for configuring the computer device as a multi-processor system. Further, each processor may be comprised of a single core or a plurality of cores. The memory 106 may include a main memory, a read only memory, and mass storage devices such as various disk drives, tape drives, etc. The main memory typically includes dynamic random access memory (DRAM) and high-speed cache memory. In operation, the main memory stores at least portions of instructions and data for execution by the processor 104.

The memory 106 may also comprise a mass storage with one or more magnetic disk or tape drives or optical disk drives, for storing data and instructions for use by processor 104. For a workstation PC, for example, at least one mass storage system in the form of a disk drive or tape drive, stores the operating system and application software. The mass storage may also include one or more drives for various portable media, such as a floppy disk, a compact disc read only memory (CD-ROM), or an integrated circuit non-volatile memory adapter (i.e. PC-MCIA adapter) to input and output data and code to and from the first computing device 102.

The first computing device network interface 108 may be more than one interface, shown by way of example as an interface for data communications via a network 110. The interface may be a modem, an Ethernet card, or any other appropriate data communications device. The physical communication links may be optical, wired, or wireless.

The first computing device 102 may further include appropriate input/output ports on lines 118 and 120 for user interface interconnection, respectively, with a display 122 and a keyboard 124. For example, the first computer device may include a graphics subsystem to drive the output display. The output display 122 may include a cathode ray tube (CRT) display or liquid crystal display (LCD). The input control devices for such an implementation may include the keyboard for inputting alphanumeric and other key information. The input control devices on line 124 may further include a cursor control device (not shown), such as a mouse, a touchpad, a trackball, stylus, or cursor direction keys. The links to the peripherals on line 124 may be wired connections or use wireless communications. Although not explicitly shown, the first computing device 102 may further comprise co-processors, associated digital signal processors (DSPs), and associated graphics processing units (GPUs).

Although the details are not expressly shown as with the first computer device 102, the online meeting scheduling service 130 and associated email client 132 may be enabled as software applications in a second computing device 134. Likewise, email clients for meeting attendees may be enabled in computing devices 136-0 through 136-n.

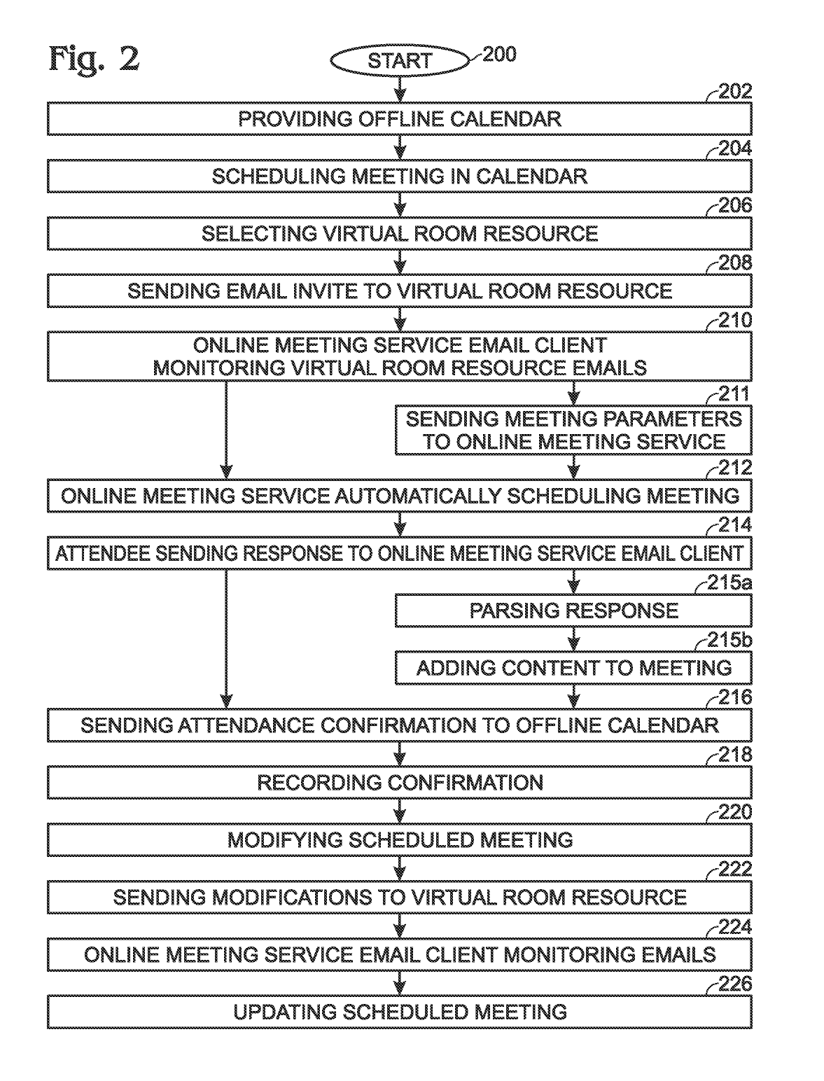

FIG. 2 is a flowchart illustrating a method for integrating an online meeting with an offline calendar. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 200.

Step 202 provides an offline calendar, enabled as a sequence of software instructions stored in a memory and executed by a microprocessor. In Step 204 a meeting originator schedules a meeting in the offline calendar via a user interface. Step 206 selects a virtual room resource having an email address. The virtual room resource can be selected automatically by the calendar or by the meeting originator. In one aspect, the virtual room resource is associated with an actual room having a physical location. Alternatively, the virtual room resource has no physical location, and is identified only by its email address. In Step 208 the offline calendar sends an email meeting invitation to the virtual room resource email address.

In Step 210 an online meeting service, enabled as a sequence of software instructions stored in a memory and executed by a microprocessor, has an email client monitoring emails sent to the virtual room resource email address. In one aspect, the online meeting service email client parses emails sent to the virtual room resource searching for an attachment in a format such as iCAL or VCALENDAR formats. vCalendar and iCal support private software extensions, with a “X-” prefix, a number of which are in common usage. For example:
X-MICROSOFT-CDO-ALLDAYEVENT—Microsoft Outlook all day event flag;
X-MICROSOFT-CDO-BUSYSTATUS—Microsoft Outlook status information;
X-WR-CALNAME—The display name of the calendar.

Here is an example of information in vCalendar format:

BEGIN:VCALENDAR
VERSION:1.0
BEGIN:VEVENT
CATEGORIES:MEETING
STATUS:TENTATIVE
DTSTART:20110401T033000Z
DTEND:20110401T043000Z
SUMMARY:New Business
DESCRIPTION:Group to suggest potential new clients
CLASS:PRIVATE
END:VEVENT
END:VCALENDAR

As used herein, the terms “online” and “offline” refer to the location where a meeting is held. Conventional electronic calendars, like Outlook, are designed to schedule meetings in physical rooms with the people present. Online meeting services schedule virtual meetings via the Internet and the attendees being network-connected computers. The calendar application described herein is referred to as an offline calendar because it initially schedules the meeting offline, and the offline meeting is automatically converted into an online meeting.

In one aspect, the online meeting service email client parses emails sent to the virtual room resource (Step 210) searching for meeting parameters such as title, location, agenda, meeting originator, time, attendees, and combinations of the above-mentioned parameters. Subsequent to parsing the attachment, in Step 211 the online meeting service email client sends the meeting parameters to the online meeting service via a web service call. In Step 212 the online meeting service automatically schedules an online meeting associated with the virtual room resource.

In one aspect, selecting the virtual room resource in Step 206 further includes selecting meeting attendees. Then, sending the email meeting invitation to the virtual room resource email address in Step 208 includes sending an attendees list with the email meeting invitation. Monitoring emails sent to the virtual room resource email address in Step 210 includes the online meeting service email client parsing the monitored email to discover the attendees list, and in Step 212 the online meeting service email client sends each attendee an online meeting invitation via an associated attendee email address.

In response to receiving the online meeting invitation, a first attendee in Step 214 sends an email invitation response to the online meeting service email client. In Step 216 the online meeting service sends an attendance confirmation associated with the first attendee to the offline calendar. In Step 218 the offline calendar records the attendance confirmation. For example, the attendance confirmation can be sent as a web service call. The World Wide Web Consortium (W3C) defines a “Web service” as a software system designed to support interoperable machine-to-machine interaction over a network. It has an interface described in a machine-processable format (specifically Web Services Description Language WSDL). Other systems interact with the Web service in a manner prescribed by its description using Simple Object Access Protocol (SOAP) messages, typically conveyed using Hypertext Transfer Protocol (HTTP) with an XML serialization in conjunction with other Web-related standards. The W3C identifies two major classes of Web services, Representational State Transfer (REST)-compliant Web services, in which the primary purpose of the service is to manipulate XML representations of Web resources using a uniform set of “stateless” operations; and arbitrary Web services, in which the service may expose an arbitrary set of operations.

In another aspect, scheduling the meeting in the offline calendar in Step 204 includes adding a first electronic document as a scheduled meeting-associated document. Documents in Word, Adobe, or ASCII plain text are examples of electronic documents. Then, sending the email meeting invitation to the virtual room resource email address in Step 208 includes sending the first electronic document as an email attachment, and sending each attendee the online meeting invitation via the associated attendee email address in Step 212 includes sending the first electronic document as an email attachment.

In one aspect, subsequent to scheduling the meeting, the meeting originator in Step 220 performs a scheduled meeting modification in the offline calendar such as canceling the meeting or changing a scheduled meeting parameter. In Step 222 the offline calendar sends an email with the scheduled meeting modification to the virtual room resource email address. In Step 224 the online meeting service email client monitors emails sent to the virtual room resource email address for scheduled meeting modifications. In Step 226 the online meeting service automatically updates the scheduled meeting with the scheduled meeting modification.

In a different aspect, the first attendee sending the email invitation response to the online meeting service email client in Step 214 attaches a second electronic document to the email invitation response. In Step 215a the online meeting service email client parses the email invitation response to determine that the email is a reply to the scheduled meeting, and in Step 215b the second electronic document is added as a scheduled meeting-associated document. For example, the second electronic document can be preloaded as meeting content, sent to the scheduled meeting attendees, or sent to a selected list of scheduled meeting attendees. In one aspect, Step 215b adds the second electronic document after verifying that the document is in an approved document format. Some examples of approved formats might be Microsoft Office documents, Adobe PDF, standard image formats, and ASCII plain text documents.

In another variation, the first attendee replies to the email invitation in Step 214 by sending a text message in the body of the first email invitation response. Then, in Step 215a the online meeting service email client parses the first email invitation response to discover the text message. In Step 215b the online meeting service adds the text message as a scheduled meeting-associated document or a textual note to the scheduled meeting.

FIG. 3 is a flowchart illustrating a method for planning an online meeting from an offline calendar. The method begins at Step 300. Step 302 provides an offline calendar, enabled as a sequence of software instructions stored in a memory and executed by a microprocessor. In Step 304 a meeting originator schedules a meeting in the offline calendar via a user interface. Step 306 selects a virtual room resource having an email address. In Step 308 the offline calendar sends an email meeting invitation to the virtual room resource email address. In one aspect, the virtual room resource may be associated with an actual room having a physical location. In Step 310 the offline calendar receives an online meeting confirmation from the online meeting service.

In one aspect, selecting the virtual room resource in Step 306 further includes selecting meeting attendees, and sending the email meeting invitation to the virtual room resource email address in Step 308 includes sending an attendees list with the email meeting invitation. In Step 312 the offline calendar receives online meeting attendance confirmations from the online meeting service, and in Step 314 the offline calendar records the attendance confirmation. For example, the online meeting attendance confirmations are received as a web service call.

In another aspect, scheduling the meeting in the offline calendar in Step 304 including adding a first electronic document as a scheduled meeting-associated document. Then, sending the email meeting invitation to the virtual room resource email address in Step 308 includes sending the first electronic document as an email attachment.

FIG. 4 is a schematic block diagram depicting participants integrating an offline calendar with an online meeting.

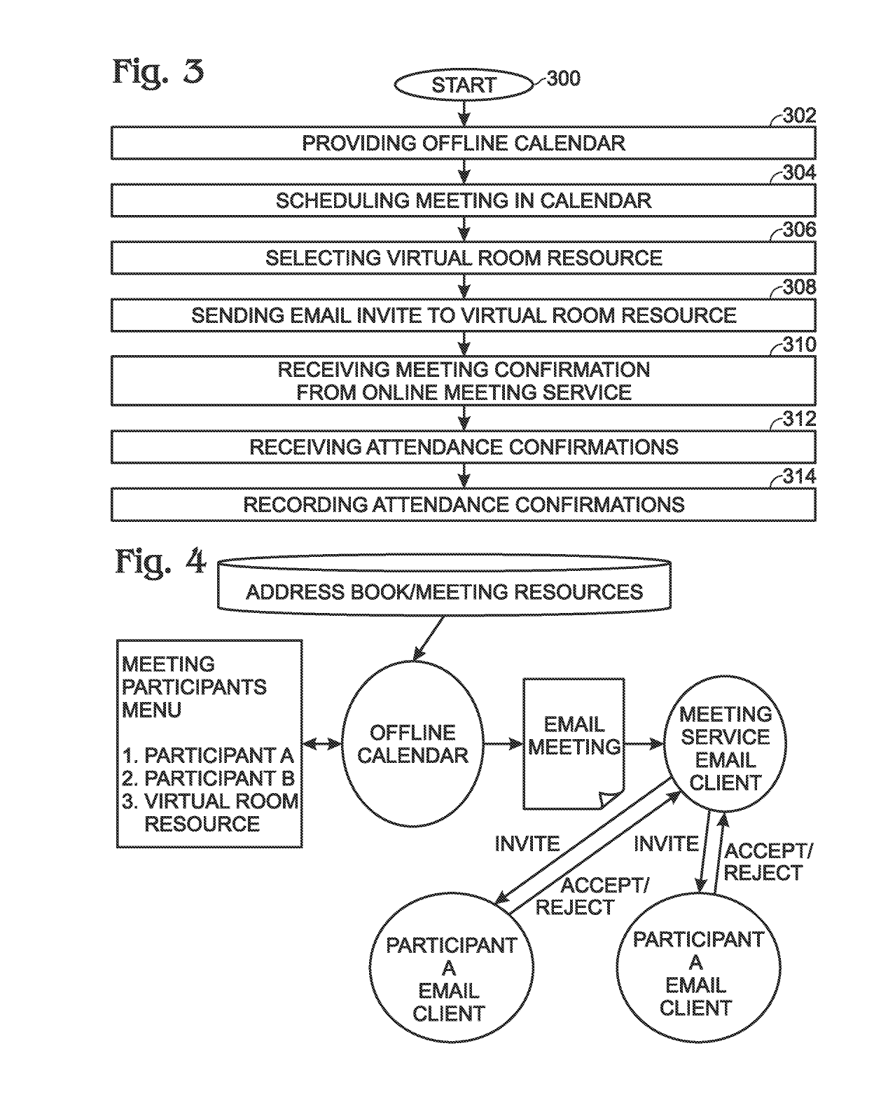

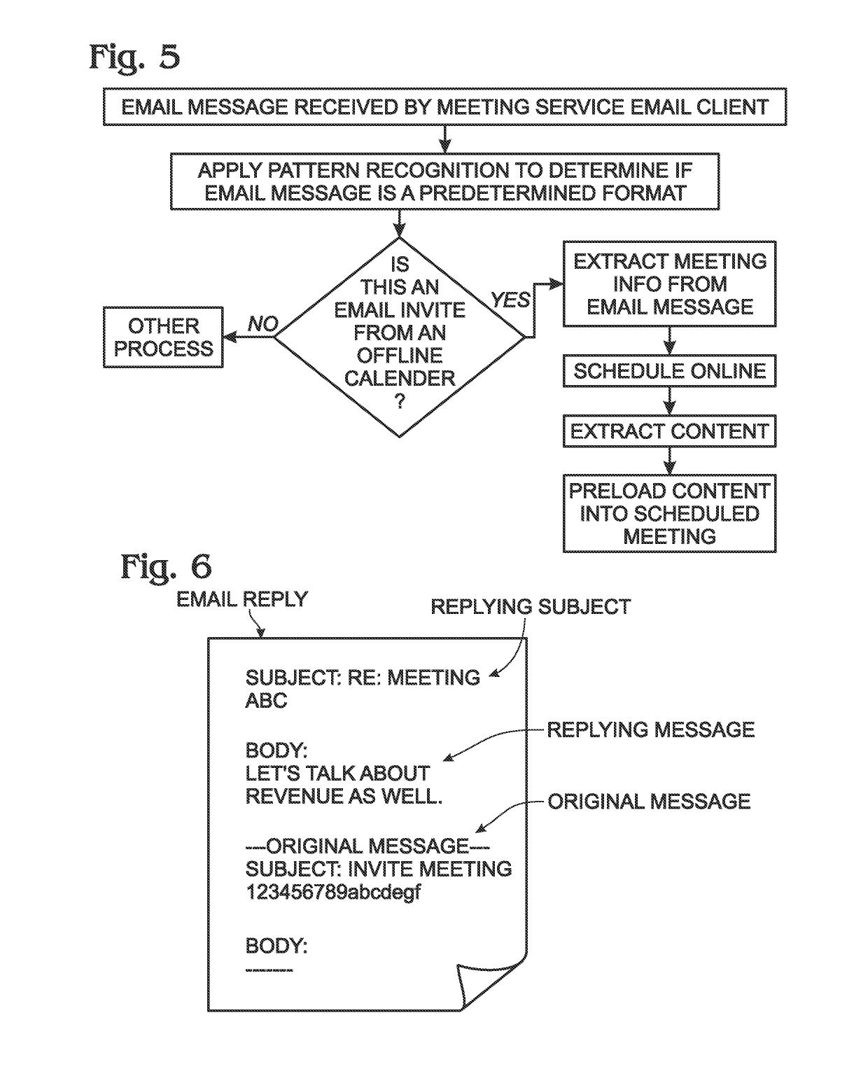

FIG. 5 is a flowchart illustrating the process by which the online service email client extracts meeting information from an email sent to a virtual room resource by an offline calendar. In the exemplary operating environment, a meeting is scheduled with an offline meeting calendar. Each invited attendee has an email address associated with them. The offline meeting calendar sends an electronic invitation to each meeting participant, such as by using email. Each attendee receives the invite message via a client application, such as an email client. Typically, the client application is an offline application running on a computing device, such as a PC, laptop or mobile device. The attendee may additionally receive and send documents using the offline client application, sending documents as email attachments. In the case of an email client, the organizer may schedule a meeting with an offline calendar, and include one or more documents in the scheduled meeting. The offline calendar would then construct an email invite message to each participant which would contain the included documents as email attachments.

Additionally, the meeting organizer may select other types of (non-person) participants. A common example is a physical meeting resource, such as a conference room. The other participant resources may also have an electronic address (e.g., email address) associated with them and a computer process monitoring the electronic address running on a computing device, such as a server. The online meeting service email client may send an email notification of the scheduled meeting to the email address(es) of the other types of (non-person) participants.

Additionally, one or more physical conference rooms are setup for a virtual meeting either or both as an online room meeting or as an online multi-site meeting. In the former case, the conference room would be connected to a computing device which runs a computer process for managing and operating an online room meeting. Typically, the conference room would have a large digital display device (e.g., LCD) which is the output display of the online room meeting process. The conference room would also have input devices for human interaction with the online room meeting process. Such devices may include: touch screen input on the large digital display device, gesture recognition, keyboard, and mouse.

In the latter case, the conference room would be connected to a computing device which runs a computer process for connecting to and operating an online multi-site meeting (e.g., Microsoft Net Meeting, Cisco WebEx, Microsoft Live Meeting). The multi-site points may he connected over the Internet, or within a corporate intranet. The meeting management process may be hosted at a 3^{rd} party service, internally on a server, locally on the meeting location's designated meeting computing device, or built into the meeting room display device.

### EXAMPLE

### Scheduling: Room Selection

A physical meeting room resource in an offline calendar has configured a second resource identifier. The second resource identifier is designated as reserving and scheduling the physical meeting room resource for both an offline (physical) and online (virtual) meeting. For example, the conference room A may have the following configured resources in an email address book:

| Resource Name | Email Address | Comment |
|---|---|---|
| Conference Room A | confA@mycompany.com | Physical Meeting |
| Conference Room | confAonline@mycompany.com | Physical and |
| A-online | | Online Meeting |

When scheduling a meeting in a meeting room that is both a physical and online meeting, the organizer selects the resource associated with the room as both a physical and online meeting. Alternately, the meeting organizer may select both the resource associated with the physical room and the resource associated with the physical/online room.

In this case, the user can guarantee that the offline calendar program would detect scheduling conflicts with the room as a physical resource.

The meeting organizer would additionally specify other meeting parameters. These would typically include: Meeting Participants, Meeting Time (start, end), Meeting Title, Meeting Location (maybe implied from meeting resource), and Meeting Agenda.

The meeting organizer may additionally import content for the meeting by specifying the content in the meeting scheduler. For example, in the offline calendar, a meeting organizer can include documents as attachments when scheduling the meeting, in the same manner as adding documents to an email message entered in MS Outlook. The documents then become attachments to the email invite message that the offline calendar sends to the virtual room resource.

### EXAMPLE

### Online Meeting Email Client

An automated online meeting email client is configured to receive email messages sent to the online meeting resource. For example, the online meeting email client may be constructed using the open source OpenPOP3 code which implements a C# API to a POP3 email client. The code can then be embedded into a background process which connects to the email server associated with the email account (e.g., corporate email server), authenticates itself (email username/password), and periodically checks for new email messages. When a new email message is received, the process automatically parses the email message for its subject, body, sender and receivers, as well as extracts any document or other media attachments.

After parsing the message, the online meeting service email client examines the parsed information to determine if the email message is from an offline meeting scheduler. For example, the email invite message may contain a non-visible attachment which contains the meeting calendar information in a VCALENDER format. This attachment is programmatically accessible. For example, one could do this using the open source OpenPOP3 code as follows:

```
// create a POP3 email client
popClient = new POPClient( );
// connect to MS Exchange Server
popClient.Connect(EmailReadServerAddress, POPPort);
// Authenticate as online meeting resource
popClient.Authenticate( UserName, Password );
// Look for new messages
int nMailCount = popClient.GetMessageCount( );
// Examine each new email message
OpenPOP.MIMEParser.Message msgMail;
for ( int i = 1; i <= nMailCount; i++ )
    {
    // Get the entire email message
    msgMail = popClient.GetMessage(i, false);
    // Get the message body
    System.Collections.ArrayList al = msgMail.MessageBody;
    // Get the attachments
    al = msgMail.Attachments;
    OpenPOP.MIMEParser.Attachment[ ] atlist = new
        OpenPOP.MIMEParser.Attachment[ al.Count ];
    al.CopyTo( atlist );
    // ....
}
```

The online meeting service email client may examine each attachment to determine if it is a VCALENDAR type. One method of determination is to match the content type against a predetermined set of content types indicative of a VCALENDAR formatted data. For an offline calendar application, a VCALENDAR attachment may appear as the content type: “text/calendar”. Below is an example using the open source OpenPOP3:

// Attachment is a VCalendar data
if ( atlist[ j ].ContentType == “text/calendar” )
{
...

In another example, the VCALENDAR data may be embedded with other data in a multi-part attachment. In this case, the multi-part content can he examined for a unique file format signature (e.g., BEGIN″VCALENDAR) indicating that a VCALENDAR data is embedded in the multi-part attachment. Below is an example:

```
if ( atlist[ j ].ContentType == “multipart/alternative” )
{
    // check if multipart data has an embedded VCalendar
    isVCalendar = atlist[ j ].RawAttachment.Contains(
                “BEGIN:VCALENDAR” );
```

If the attachment is or contains a VCalendar data object, then the attachment can he parsed according to a predetermined VCalendar format. Below is an example high-level code for parsing VCALENDAR data extracted from an attachment:

// Get the calendar data in raw format (MS Outlook EML format)
string rawCalendarData = atlist[ j ].RawAttachment;
// Create a VCalendar object to process the VCalendar data
VCalendarOutLook _mtg = new VCalendarOutLook( rawCalendarData );
// Parse the meeting information from the VCalendar data
_mtg.Parse( );
// Get the meeting information from the parsed VCalendar data

| | |
|---|---|
| string mtgTitle | = _mtg.Summary; |
| string mtgLocation | = _mtg.Location; |
| string mtgAgenda | = _mtg.Description; |
| ArrayList mtgOrganizer | = _mtg.Organizer; |
| ArrayList mtgTime | = _mtg.Time; |
| ArrayList mtgAttendees | = _mtg.Attendees; |

### EXAMPLE

### Scheduling Online Meeting from Offline Meeting Data

Once the online meeting service email client has parsed the email meeting invite from the offline calendar, the parsed information is then used to automatically schedule a corresponding online meeting. The online meeting is generally scheduled as follows:

The virtual room is set to the meeting room associated with the email address of the virtual room resource.

The physical location is set to the location specified by the offline calendar email.

The meeting title is set to the title specified in the offline calendar email (e.g., Summary).

The meeting agenda is set to the agenda specified in the offline calendar email (e.g., Description).

The meeting start and optional end-time are set to the start/end meeting times in the offline calendar email.

The meeting organizer is set to the user that scheduled the offline calendar email (e.g., Organizer).

The meeting attendees are set to the non-resource participants in the offline calendar email.

Below is a code snippet showing the meeting information extracted from the meeting information in the email invite message as the online meeting parameters which are passed to the online meeting scheduler via a web service call.

// Create GUID identifier for Meeting
meetingGUID = Guid.NewGuid( ).ToString( );
// Schedule Meeting in Xanthus database
if ( SharpCoServer.SharpCoWSCore.Service.CreateOnlineMeeting(

meetingGUID,
mtgTitle,
VCalendar.GetStartTime( mtgTime ),
mtgLocation,
VCalendar.GetAttendeeName ( mtgOrganizer ),
VCalendar.GetAttendeeNames( mtgAttendees ),
“”, // objective
strAttendeeList) == false )

```
{
    SetResult(“Scheduling online meeting failed”);
    ...
}
```

### EXAMPLE

### Scheduling: Preloading Content from Offline Meeting Email

In another aspect, the online meeting service email client additionally parses the offline meeting email invite message for any document attachments (e.g., non-hidden files). Each document attached to the email invite message may either be automatically added to the scheduled online meeting or first be pre-checked against a set of predetermined conditions for preloading documents to the scheduled meeting. There may restrictions on supported document formats

For example, the meeting scheduler may be configured to only allow MS Office documents, Adobe PDF, standard image formats, and ASCII plain text documents. In one example, the document suffix may be used to determine the document type (e.g., .doc for MS-Word). In another example, an initial byte sequence of the document may be examined to identify a unique file format signature.

```
      // Open the attachment for reading
      FileStream fs = File.Open( attachment, FileMode.Open,
FileAccess.Read );
      // Read the first 4 bytes of the attachment
      byte [ ] signature = new byte[4];
      fs.Read( signature, 0, 4 );
      // Get Format Type
      FormatType format = GetFormat ( signature);
      switch ( format )
      {
      case FormatType.MSWord: ...
```

There may be restrictions on document owners. For example, the meeting scheduler may be configured to only allow documents authored by the organizer or attendees. In one example, a file operation may be executed on the document to obtain owner and other file information stored with the file (e.g., C# File.GetFileAttributes, File.GetCreationTime, etc).

There are be restrictions related to document metadata, such as copyright or confidentiality. For example, metadata may be attached to a file at a predetermined location, such as the end of the document. The document can then be opened and the metadata read from the predetermined location. The metadata can then be compared to a set of predetermined rules.

There may be restrictions based on attendee audience. For example, the meeting scheduler may lookup each participant's role in the organization to determine what kind of documents the may or may not be allowed to view. In one example, the role of a document owner is HR (human resources), and one of the participant's role is a non-manager. A predetermined role may restrict adding HR documents to meetings that are attended by a non-management personnel.

If the document is accepted for the scheduled meeting, the document is stored in a meeting specific repository. For example, the online meeting email client may store the document in a meeting repository which is accessible by both the online meeting email client and the online meeting service. The online meeting email client could store the document in a document folder reserved for the meeting by the meeting scheduler.

```
      // Construct meeting specific document folder in online
meeting
      // document repository
      string documentDirectory = documentRepository + “\\” +
meetingGUID;
      // Construct document repository for meeting, if it does not
exist
      if ( Directory.Exists(meetingDirectory) == false )
            Directory.CreateDirectory( meetingDirectory );
      // Construct path for storing document in meeting specific
document
      // folder
      string filePath = meetingDirectory + “\\” +
attachment.ContentFileName;
      // Save document to meeting specific document folder
      msgMail.SaveAttachment( attachment, filePath ) )
```

### EXAMPLE

### Scheduling: Reply to Meeting Email Invite

In another aspect, the offline meeting scheduler sends an email meeting invite to each attendee specified in the scheduling of the meeting with the offline meeting scheduler. The attendee may optionally respond (reply back) to the email invite to include additional content (e.g., documents) in the meeting.

In this case, the attendee would respond to the associated online meeting resource and include in the response as attachments the content to preload into the meeting. Upon receiving the response, the online meeting email client would parse the response (as described earlier). As part of the parsing the response, the online meeting email client would detect that the email message is a reply-to message and not an original message. For example, it may detect this by the presence of a ‘Re:’ prefix in the subject line.

When the email message is a response and not an original message, the online meeting email client would examine the parsed information to identify the meeting. In one example, the reply to would contain a copy of the original human readable invite message which was programmatically generated by the offline meeting scheduler. The format of this message would be pre-known to the online meeting email client.

If the online meeting email client recognizes the reply to message as a reply to a known format offline calendar email invite, the online meeting email client would extract from the parsed information the unique identity of the scheduled meeting. For example, the information could be any combination of at least two of: Meeting Location, Meeting Organizer, and Meeting Time.

If the online meeting email client is able to extract sufficient meeting information, the online meeting email client would query the online meeting service to find the meeting that matches the meeting information. In one example, the online meeting email client makes a request to the online meeting service to find the meeting via a web service call, where the meeting information is passed as parameters to the web service call. The online meeting service would then use the meeting information as [non-primary] lookup keys in a database (e.g., SQL) which stores the scheduled meetings. Below is example code of the online meeting email client side:

```
    // Check if this is a Reply to
    //
    string strSubject = IsReplyTo( attachment );
    if ( null != strSubject )
    {
        // Find meeting time in attachment data
        DateTime dtMeeting = DateTime.Now;
        if ( HasMeetingTime(attachment, ref dtMeeting ) )
        {
            // Query the meeting scheduler for the meeting
GUID
            meetingGUID = SharpCoServer.SharpCoWSCore.Service.
                GetMeetingGUIDId( strSubject, dtMeeting );
```

Below is example code of the meeting scheduler side:

```
    public static string GetMeetingGUIDId( string meetingName,
                        DateTime meetingTime )
    {
      return MeetingRecords.FindMeetingRecord( meetingName,
meetingTime );
    }
    public static string FindMeetingRecord( string meetingName,
                            DateTime meetingTime )
    {
        // Formulate the database query based on the input
parameters
        using (SqlConnection DBConn = new
            SqlConnection(MeetingDatabase.DataSource))
        {
            try
            {
                // Create the connection and a command
object
                DBConn.Open( );
                SqlCommand SqlCmd = DBConn.CreateCommand( );
                // Construct SQL query
                //
                string sqlCmd =
                @“SELECT * FROM MeetingsTable WHERE
                MeetingName = ‘“ + meetingName + ”’ AND
                MeetingDateTime = ‘“ +
                meetingTime.ToString( ) +”’”;
                SqlCmd.CommandText = sqlCmd;
                // Query the SQL database
                //
                SqlDataReader MtgListReader =
SqlCmd.ExecuteReader( );
                // Meeting not found
                //
                if ( MtgListReader.Read( ) == false )
                    return null;
                return MtgListReader.GetGuid(0).ToString( );
        }
        catch
        {
            return null;
        }
      }
    }
```

If the meeting scheduler is able to identify the meeting, it returns the unique meeting identifier back to the online meeting email client. The online meeting email client then stores any document attachments (verified for inclusion) into the document folder assigned to the meeting, such as by the methods described earlier.

### EXAMPLE

### Scheduling: Meeting Cancelation

In another aspect, the organizer of an online meeting that was scheduled via an offline calendar cancels the meeting using the offline calendar. When a meeting is canceled, the offline calendar sends an offline meeting cancelation notice to each attendee and meeting resource. Alternatively, the online meeting service email client sends the cancellation notices to the attendees. The meeting cancelation email message is sent to the virtual room resource. The online meeting email client then receives the message.

After the cancelation email message is parsed by the online meeting email client, the online meeting email client examines the parsed information to determine if the email message is a meeting cancelation. In one example, this is determined by the subject line prefixed by the string “Canceled”.

After the online meeting email client has determined the email message to be a meeting cancelation message, the online meeting email client examines the parsed email message and attachments (e.g., VCalendar attachment) to locate the scheduled meeting information. If the online meeting email client is able to extract sufficient meeting information, the online meeting email client would query the online meeting service to find the meeting that matches the meeting information (such as by the means described earlier).

If the online meeting service is able to identify the meeting, the unique meeting identifier is returned to the online meeting email client. The online meeting email client then makes a call to the online meeting service to cancel the identified meeting. For example, the online meeting email client may make a web service call for a meeting cancelation, passing the unique meeting identifier as a parameter to the call.

```
// Query the meeting scheduler for the meeting GUID
meetingGUID =
SharpCoServer.SharpCoWSCore.Service.GetMeetingGUIDId(
                strSubject, dtMeeting );
// Request the meeting scheduler to cancel the meeting
if ( meetingGUID != null )
    SharpCoServer.SharpCoWSCore.Service.CancelMeeting(
meetingGUID );
```

### EXAMPLE

### Scheduling: Meeting Update

In another aspect, the organizer of an online meeting that was scheduled via an offline calendar updates the meeting using the offline meeting scheduler. An update may include, but not limited to, any of the following: Meeting Time, Meeting Location, Meeting Subject, Meeting Agenda, and Add/Remove meeting participants.

In one example, the updated offline email meeting invite contains a ‘Update:’ prefix in the subject line. If the online meeting email client detects the presence of the ‘Update: prefix, it enters the mode of updating an existing scheduled online meeting instead of scheduling a new one.

The update offline email invite message will additionally contain information on the new meeting parameters. The online meeting email client would first extract from the update offline email invite message the meeting parameters that either would not change or are the least likely to change, to use as keys in a lookup to find the previous scheduled meeting.

For example, the meeting organizer would not change. The online meeting email client would then look for one other secondary meeting key that would be the least likely to change, such as the meeting title. Typically, the most likely fields to change would be (in order): the meeting participants, the meeting time, the meeting agenda, the meeting location, and the meeting name. An attempt would then be made to identify the unique meeting ID by querying the meeting database with the secondary meeting keys (as described earlier).

If the meeting is identified, the online email client would then issue a call (e.g., web service) to the online meeting service to modify the values of the named fields for a specific meeting identified by the unique meeting ID.

### EXAMPLE

### Scheduling: Reply to Meeting Email Invite: Preloading of Notes

A shared notes file can be pre-populated by the participants as part of accepting or otherwise responding to an online meeting invite. In one variation, participants respond to the email meeting invite with content to include (e.g., attachments), and participants may preload notes to a meeting prior to the start of the meeting. In one example, the attendees respond to an email invite from the meeting service, which allows them to attach documents which are included in the meeting.

FIG. 6 is a drawing illustrating an invitation reply email. In this example, the attendee may also add text to the body of the reply message. The online meeting service's email client then would detect and extract the textual message from the reply to the meeting invite email message. The text would then be treated as an initial note to a meeting wide shared note file.

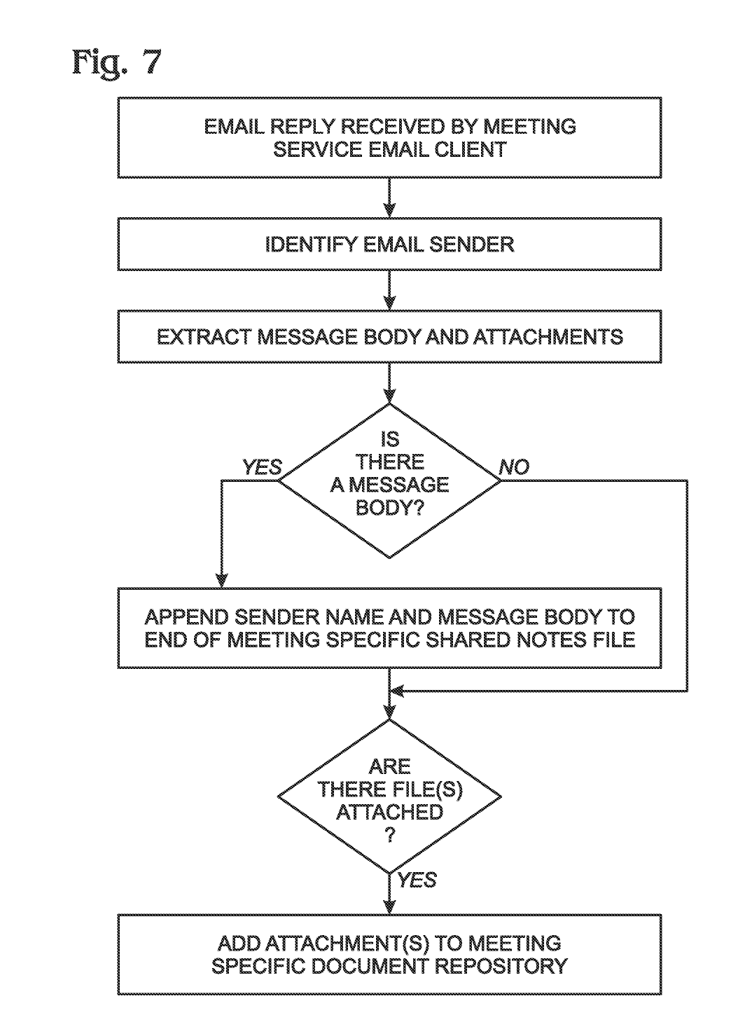

FIG. 7 is a flowchart illustrating an invitation reply parsing process. Typically, the text would be appended to a pre-created notes file with the user's name and other identifying information attached to it. The pre-created notes file could then be automatically displayed at the start of the meeting, or displayed at the host's request, or reviewed privately by the individual attendees. Below is a code example extracting a message body from a reply for a shared notes file.

```
    public ReadResult Parse( string _strDocumentStorage )
    {
        ...
        // UPloading Content to the Meeting
        //
        if ( res == ReadResult.Uploaded )
        {
            // Look for original message portion of a Reply To
            //
            int index = body.IndexOf( “> _” );
            if ( index < 0 )
                index = body.IndexOf( “-----Original Message-----” );
            if ( index < 0 )
                index = body.IndexOf( “From:” );
            if ( index > 0 )
            {
                // Extract the notes portion of the email
message
                //
                string notes = body.Substring( 0, index ).Trim( );
                if ( notes.Length > 0 )
                {
                    try
                    {
                        // Append the sender's name and note to
the end of the ‘notes’ file
                        //
                        FileStream fsNotes =
File.Open(meetingDirectory + “/notes.txt”, FileMode.Append,
FileAccess.Write, FileShare.None);
                        byte[ ] b = ASCIIEncoding.ASCII.GetBytes(
VCalendar.GetAttendeeName( from ) + “:\r\n\r\n” + notes + “\r\n\r\n” );
                        fsNotes.Write(b, 0, b.Length);
                        fsNotes.Close( );
                        SetResult( “Added note to meeting from
user: ” + VCalendar.GetAttendeeName( from ) + “, GUID = ” +
meetingGUID );
                    }
                    catch
                    {
                    }
                }
            }
        }
```

A method has been provided for integrating an offline calendar with an online meeting service. Examples of particular message structures, formats, and software instructions have been presented to illustrate the invention. However, the invention is not limited to merely these examples. Other variations and embodiments of the invention will occur to those skilled in the art.

We claim:

1. A method for integrating an online meeting with an offline calendar, the method comprising:
providing an offline calendar, enabled as a sequence of software instructions stored in a memory and executed by a microprocessor;
a meeting originator scheduling a meeting in the offline calendar via a user interface;
selecting a virtual room resource having an email address;
the offline calendar sending an email meeting invitation to the virtual room resource email address;
an online meeting service, enabled as a sequence of software instructions stored in a memory and executed by a microprocessor, having an email client monitoring emails sent to the virtual room resource email address; and,
the online meeting service automatically scheduling an online meeting associated with the virtual room resource.

2. The method of claim 1 wherein selecting the virtual room resource further includes selecting meeting attendees;
wherein the offline calendar sending the email meeting invitation to the virtual room resource email address includes sending an attendees list with the email meeting invitation;
wherein the online meeting service email client monitoring emails sent to the virtual room resource email address includes the online meeting service email client parsing the monitored email to discover the attendees list; and,
the method further comprising:
the online meeting service email client sending each attendee an online meeting invitation via an associated attendee email address.

3. The method of claim 2 further comprising:
in response to receiving the online meeting invitation, a first attendee sending an email invitation response to the online meeting service email client;
the online meeting service sending an attendance confirmation associated with the first attendee to the offline calendar; and,
the offline calendar recording the attendance confirmation.

4. The method of claim 3 wherein the online meeting service sending the attendance confirmation associated with the first attendee to the offline calendar includes sending the attendance confirmation as a web service call.

5. The method of claim 2 wherein scheduling the meeting in the offline calendar including adding a first electronic document as a scheduled meeting-associated document;
wherein the offline calendar sending the email meeting invitation to the virtual room resource email address includes sending the first electronic document as an email attachment; and,
wherein the online meeting service email client sending each attendee the online meeting invitation via the associated attendee email address includes sending the first electronic document as an email attachment.

6. The method of claim 1 further comprising:
subsequent to scheduling the meeting, the meeting originator performing a scheduled meeting modification in the offline calendar selected from a group consisting of canceling the online meeting and changing a scheduled meeting parameter;
the offline calendar sending an email with the scheduled meeting modification to the virtual room resource email address;
the online meeting service email client monitoring emails sent to the virtual room resource email address for scheduled meeting modifications; and,
the online meeting service automatically updating the scheduled meeting with the scheduled meeting modification.

7. The method of claim 1 wherein selecting the virtual room resource additionally includes selecting the virtual room resource associated with an actual room having a physical location.

8. The method of claim 1 wherein the online meeting service email client monitoring emails sent to the virtual room resource email address includes the online meeting service email client parsing emails sent to the virtual room resource searching for an attachment in a format selected from a group consisting of iCAL and VCALENDAR formats.

9. The method of claim 8 wherein the online meeting service email client parsing emails sent to the virtual room resource searching for the attachment in the selected format includes parsing an attachment in the selected format for meeting parameters selected from a group consisting of title, location, agenda, meeting originator, time, attendees, and combinations of the above-mentioned parameters.

10. The method of claim 8 further comprising:
subsequent to parsing the attachment in the selected format, the online meeting service email client sending the meeting parameters to the online meeting service via a web service call.

11. The method of claim 3 wherein the first attendee sending the email invitation response to the online meeting service email client includes the first attendee attaching a second electronic document to the email invitation response;
the method further comprising:
the online meeting service email client parsing the email invitation response to determine that the email is a reply to the scheduled meeting; and,
adding the second electronic document as a scheduled meeting-associated document.

12. The method of claim 11 wherein adding the second electronic document as the scheduled meeting associated document includes performing an operation selected from a group consisting of a sending the second electronic document to the scheduled meeting attendees and sending the second electronic document to a selected list of scheduled meeting attendees,

13. The method of claim 11 wherein adding the second electronic document as a scheduled meeting-associated document includes adding the second electronic document after verifying that the document is in an approved document format selected from a group consisting of Microsoft Office, Adobe PDF, standard image formats, and ASCII plain text.

14. The method of claim 3 wherein the first attendee sending the email invitation response to the online meeting service email client includes the first attendee sending a text message in the body of the first email invitation response;
the method further comprising:
the online meeting service email client parsing the first email invitation response to discover the text message; and,
the online meeting service adding the text message as an element selected from a group consisting of a scheduled meeting-associated document and a textual note to the scheduled meeting.

15. A method for planning an online meeting from an offline calendar, the method comprising:
providing an offline calendar, enabled as a sequence of software instructions stored in a memory and executed by a microprocessor;
a meeting originator scheduling a meeting in the offline calendar via a user interface;
selecting a virtual room resource having an email address;
the offline calendar sending an email meeting invitation to the virtual room resource email address; and,
the offline calendar receiving an online meeting confirmation from the online meeting service.

16. The method of claim 15 wherein selecting the virtual room resource further includes selecting meeting attendees;
wherein the offline calendar sending the email meeting invitation to the virtual room resource email address includes sending an attendees list with the email meeting invitation;
the method further comprising:
the offline calendar receiving online meeting attendance confirmations from the online meeting service; and,
the offline calendar recording the attendance confirmation.

17. The method of claim 15 wherein the offline calendar receiving online meeting attendance confirmations from the online meeting service includes receiving the attendance confirmation as a web service call.

18. The method of claim 15 wherein scheduling the meeting in the offline calendar including adding a first electronic document as a scheduled meeting-associated document; and,
wherein the offline calendar sending the email meeting invitation to the virtual room resource email address includes sending the first electronic document as an email attachment.

19. The method of claim 15 wherein selecting the virtual room resource having the email address additionally includes selecting the virtual room resource associated with an actual room having a physical location.

20. A method for integrating an online meeting with an offline calendar enabled as a sequence of processor executable software instructions stored on a tangible computer-readable medium, the instructions comprising:
a menu for scheduling a meeting in the offline calendar via a user interface;
a menu for selecting a virtual room resource having an email address;
sending an email meeting invitation to the virtual room resource email address; and,
receiving an online meeting confirmation from an online meeting service.
